(19) United States
(12) Patent Application Publication
(10) Pub. No.: US 2012/0235540 A1
(43) Pub. Date: Sep. 20, 2012

(54) DRIVING APPARATUS

(75) Inventor: Jun Suzuki, Fujimino-shi (JP)

(73) Assignee: PIONEER CORPORATION,, Kanagawa (JP)

(21) Appl. No.: 13/510,739

(22) PCT Filed: Jun. 18, 2010
(86) PCT No.: PCT/JP10/60381

§ 371 Date: May 30, 2012

(30) Foreign Application Priority Data
Nov. 19, 2009 (JP) PCT/JP2009/069636

(51) Int. Cl. H02N 2/04; H02K 33/12

(52) U.S. Cl. 310/323.17; 310/12.06

(57) ABSTRACT

A driving apparatus (100) is provided with: a base part (110); a stage part (130) on which a driven object (150) is mounted and which can be displaced; an elastic part (120) which has elasticity for displacing the stage part along one direction (Y axis); and an applying part (110) for applying to the base part microvibration for displacing the stage part (130) such that the stage part (130) resonates along the one direction (Y axis) at a resonance frequency determined by the elastic part (120) and the stage part (130), the microvibration is non-directional microvibration as non-directional vibrational energy.

### TECHNICAL FIELD

The present invention relates to a driving apparatus for driving, for example, a stage or the like on which a driven object is mounted in a uniaxial direction or biaxial directions.

### BACKGROUND ART

In various technical fields such as, for example, a display, a printing apparatus, precision measurement, precision processing, and information recording-reproduction, research on a micro electro mechanical system (MEMS) device manufactured by a semiconductor fabrication technology is actively progressing. As an example of the application of the MEMS device as described above, there is listed a probe memory for recording data onto a recording medium or reproducing the data recorded on the recording medium by displacing a probe array, which includes a plurality of probes, along a recording surface of the recording medium with respect to the planar recording medium. The probe memory as described above uses a MEMS actuator which is provided, for example, with: a fixed main body as a base; a stage on which the probe array is mounted; and a suspension for connecting or joining the main body and the stage and which can drive the stage along a planar direction. In this case, the position of the probe array with respect to the recording medium (in other words, a positional relation between the probe array and the recording medium) is determined, for example, by displacing the stage provided with the probe array. In other words, the position of the probe array with respect to the recording medium is determined by the operation of the MEMS actuator which is provided with the stage and which can displace the stage.

### PATENT DOCUMENT

Patent document 1: International Publication WO2008/126232 pamphlet

### DISCLOSURE OF INVENTION

### Subject to be Solved by the Invention

In the conventional MEMS actuator, in order to displace the state along a predetermined direction, it is necessary to apply a force acting directly along a displacement direction of the stage (in other words, a directional force). More specifically, in order to displace the stage along the predetermined direction, it is necessary to dispose a driving source, which applies a force, at a predetermined position at which the force acting along the predetermined direction can be applied to the stage. However, in the MEMS actuator for applying the directional force, the placement position of the driving source is limited. Thus, in the MEMS actuator in which there are already significant restrictions in design (particularly, restrictions in size), the degree of freedom of the design becomes even narrower.

The above can be listed as one example of the subject to be solved by the invention. It is therefore an object of the present invention to provide a driving apparatus (i.e. a MEMS actuator) capable of displacing a stage by using a force other than a directional force.

The above object of the present invention can be achieved by a driving apparatus provided with: a base part; a stage part on which a driven object is mounted and which can be displaced; an elastic part which connects the base part and the stage part and which has elasticity for displacing the stage part along one direction; and an applying part for applying to the base part microvibration for displacing the stage part such that the stage part resonates along the one direction at a resonance frequency determined by the elastic part and the stage part, the microvibration is non-directional microvibration as non-directional vibrational energy.

These operation and other advantages of the present invention will become more apparent from the embodiment explained below.

### BRIEF DESCRIPTION OF DRAWINGS

FIG. 1 is a plan view conceptually showing a configuration of a driving apparatus in a first example.

FIG. 2 is a plan view conceptually showing an aspect of operation performed by the driving apparatus in the first example.

FIG. 3 is a plan view for explaining a non-directional force caused by microvibration applied from a driving source part.

FIG. 4 is a plan view conceptually showing a configuration of a driving apparatus in a second example.

FIG. 5 is a plan view conceptually showing an aspect of operation performed by the driving apparatus in the second example.

FIG. 6 is a plan view for explaining a non-directional force caused by microvibration applied from a driving source part.

FIG. 7 is a plan view conceptually showing a configuration of a driving apparatus in a third example.

FIG. 8 is a plan view conceptually showing a configuration of a driving apparatus in a fourth example.

FIG. 9 is a plan view conceptually showing another configuration of the driving apparatus in the fourth example.

### BEST MODE FOR CARRYING OUT THE INVENTION

Hereinafter, as the best mode for carrying out the present invention, an explanation will be given to an embodiment of the driving apparatus in order.

A driving apparatus in an embodiment is provided with: a base part; a stage part on which a driven object is mounted and which can be displaced; an elastic part which connects the base part and the stage part and which has elasticity for displacing the stage part along one direction; and an applying part for applying, to the base part, microvibration for displacing the stage part such that the stage part resonates along the one direction at a resonance frequency determined by the elastic part and the stage part, and the microvibration is non-directional microvibration as non-directional vibrational energy.

According to the driving apparatus in the embodiment, the base part which is a foundation and the stage part which is movably disposed (in other words, the stage part on which the driven object is mounted) are connected directly or indirectly by the elastic part (e.g. suspensions described later or the like) having the elasticity. The driven object is displaced (in other words, vibrated) along the one direction by the elasticity of the elastic part (e.g. elasticity capable of displacing the driven object along the one direction).

In the driving apparatus in the embodiment, in particular, by the operation of the applying part, the microvibration is applied such that the stage part resonates along the one direction at the resonance frequency determined by the elastic part and the stage part (specifically, for example, the resonance frequency determined by the mass of an entire system (in other words, an entire suspended part described later) which is the stage part including the driven object mounted thereon and a spring constant of the elastic part). At this time, the applying part in the embodiment applies the microvibration to the base part such that the microvibration is propagated in the inside of a structure which is the base part. That is, the applying part in the embodiment applies the microvibration which is propagated in the inside of the structure, as excitation energy (in other words, wave-energy) for displacing the stage part. In other words, the applying part in the embodiment applies the microvibration which is propagated as energy (in other words, as energy for developing a force of “vibration” without changing the force to vibration) in the inside of the structure, as the wave-energy for displacing the stage part. The microvibration (in other words, the wave-energy propagated in the inside of the structure) is a non-directional force at least when it is propagated in the inside of the structure. In other words, the wave-energy propagated in the inside of the base part as the microvibration is propagated along an arbitrary direction in the inside of the base part. In other words, in the embodiment, the wave-energy propagated in the inside of the base part as the non-directional microvibration can be propagated along an arbitrary direction in the inside of the base part. Incidentally, the “non-directional microvibration” may be, for example, microvibration along a direction uncorrelated with a displacement direction of the stage part. As a result, the microvibration is transmitted as the wave-energy from the structure such as, for example, the base part to the elastic part (and further from the base part via the elastic part to the stage part). After that, the microvibration (in other words, the wave-energy) propagated in the inside of the structure vibrates the elastic part along a direction according to the elasticity of the elastic part or displaces the stage part along the direction according to the elasticity of the elastic part. In other words, the wave-energy can be extracted as vibration along all directions without limiting the direction of the microvibration. In other words, the wave-energy propagated in the inside of the base part can be extracted to the exterior in a form of vibration (more specifically, resonance), resulting in the displacement of the stage part. Incidentally, the wave-energy can be extracted to the exterior as a sound; however, the sound generated in this case has a different sound generation principle, in comparison with that of a sound obtained by a so-called piston motion.

Here, if the stage part is driven by applying a so-called directional force (e.g. if the base part is greatly vibrated along the displacement direction of the stage part and the vibration is directly applied to the elastic part and the stage part to drive the stage part), it is necessary to apply a directional force for displacing the stage part along the one direction (i.e. a directional force for greatly vibrating a structure such as the base part along the one direction) from the applying part. Thus, the placement position of the applying part needs to be appropriately set such that the directional force can be applied. In other words, if the directional force is applied, the placement position of the applying part is limited depending on a direction of acting the force.

In the embodiment, however, since the non-directional force caused by the microvibration (i.e. the non-directional microvibration) is applied, the placement position of the applying part is no longer limited. In other words, the application of the non-directional force caused by the microvibration does not cause such a situation that the placement position of the applying part is limited depending on the displacement direction of the stage part. That is, regardless of the placement position of the applying part, the microvibration (i.e. the non-directional force) applied from the applying part allows the stage part to be displaced along the one direction using the elasticity of the elastic part. This makes it possible to relatively increase the degree of freedom in the design of the driving apparatus.

In addition, in the embodiment, since the non-directional force caused by the microvibration (i.e. the non-directional microvibration) is applied, it is not necessary to apply the microvibration in view of a direction of the actual vibration of the stage part or the base part. In other words, it is not necessary to apply a force directly acting along a direction matching the direction of the actual vibration of the stage part or the base part. Thus, regardless of a position where the applying part is disposed, the stage part can be preferably displaced along the one direction.

In another aspect of the driving apparatus in the embodiment, the elastic part has elasticity for displacing the stage part along another direction which is different from the one direction, and the applying part applies, to the base part, the microvibration for displacing the stage part such that the stage part resonates along the one direction at a resonance frequency determined by the elastic part and a suspended part including the stage part and for displacing the stage part such that the stage part resonates along the another direction at a resonance frequency determined by the elastic part and the stage part.

According to this aspect, the elastic part has not only the elasticity for displacing the stage part along the one direction but also the elasticity for displacing the stage part along the another direction. The elastic part as described above may be realized, for example, by a first elastic part having the elasticity for displacing the stage part along the one direction and a second elastic part having the elasticity for displacing the stage part along the another direction. The elastic part as described above may be also realized, for example, by a single elastic part having both the elasticity for displacing the stage part along the one direction and the elasticity for displacing the stage part along the another direction. The stage part is displaced along each of the one direction and the another direction by the elasticity of the elastic part (e.g. elasticity capable of displacing the stage part along the one direction and elasticity capable of displacing the stage part along the another direction). In other words, the driving apparatus in this aspect can biaxially drive the stage part. Incidentally, it is obvious that multiaxial drive which is biaxial or more may be performed.

In this aspect, in particular, by the operation of the applying part, the microvibration is applied such that the stage part (in other words, the suspended part including the stage part) resonates along the one direction at the resonance frequency determined by the elastic part (more specifically, a first elastic part for suspending a second base part detailed later) and the suspended part including the stage part including the driven object (more specifically, the suspended part which is a structure for suspending the stage part including the driven object and which is a structure composed of the stage part including the driven object, the second base part, and a second elastic part detailed later). More specifically, for example, by the operation of the applying part, the microvibration is applied such that the stage part (in other words, the suspended part including the stage part) is displaced while resonating along the one direction at the resonance frequency determined by the mass of the suspended part including the stage part including the driven object (more specifically, the suspended part which is a structure for suspending the stage part including the driven object and which is a structure composed of the stage part including the driven object, the second base part, and the second elastic part detailed later) and the spring constant of the elastic part (more specifically, the first elastic part for suspending the second base part detailed later). At the same time, the microvibration allows the stage part to be displaced while resonating along the another direction at the resonance frequency determined by the elastic part (more specifically, the second elastic part detailed later) and the stage part including the driven object. More specifically, the microvibration allows the stage part to be displaced while resonating in the another direction at the resonance frequency determined by the mass of the stage part including the driven object and the spring constant of the elastic part (more specifically, the second elastic part detailed later). In other words, in this aspect, the microvibration for biaxially driving the stage part is applied from the same applying part (in other words, a single applying part).

Here, if the stage part is biaxially driven by applying a so-called directional force (e.g. if the base part is greatly vibrated along the displacement direction of the stage part and the vibration is directly applied to the elastic part and the stage part to drive the stage part), it is necessary to apply a directional force for displacing the stage part along the one direction (i.e. a directional force for greatly vibrating a structure such as the base part along the one direction) from one applying part. It is also necessary to apply a directional force for displacing the stage part along the another direction (i.e. a directional force for greatly vibrating a structure such as the base part along the another direction) from another applying part. That is, in the case where the biaxial drive of the stage is performed part by applying the directional force, usually, the driving apparatus needs to be provided with two or more applying parts (in other words, two or more driving sources). In other words, in the case where the biaxial drive of the stage part is performed by applying the directional force, because only a force that acts along the one direction can be applied from one applying part, and thus, the driving apparatus needs to be provided with two or more applying parts (i.e. two or more driving sources).

In the embodiment, however, the stage part can be biaxially driven by applying the non-directional force caused by the microvibration. Here, since the non-directional force caused by the microvibration is applied, the microvibration applied from one applying part allows the stage part to be displaced along each of the one direction and the another direction using the elasticity of the elastic part (i.e. the elasticity for displacing the stage part along the one direction and the elasticity for displacing the stage part along the another direction). In other words, in the embodiment, even in the case of the biaxial drive of the stage part, it is not always necessary to provide two applying parts. Thus, by using a single applying part (in other words, a single driving source), the microvibration for biaxially driving the stage part can be applied.

In addition, even if a force acting along two directions can be applied from one applying part, in the case where the biaxial drive of the stage part is performed by applying the directional force, it is eventually necessary to apply a force having components acting along the two directions (i.e. a directional component force for displacing the stage part along the one direction and a directional component force for displacing the stage part along the another direction). In this aspect, however, since the non-directional force caused by the microvibration is applied as the wave-energy, there is no need to apply the force in view of a direction of acting the force, which is also advantageous. In other words, there is such an advantage that it is not necessary to apply a force directly acting in a direction matching the direction of the actual vibration of the stage part or the base part.

In another aspect of the driving apparatus in the embodiment, the base part is provided with a first base part and a second base part which is at least partially surrounded by the first base part, the elastic part is provided with (i) a first elastic part which connects the first base part and the second base part and which has elasticity for displacing the second base part along the one direction and (ii) a second elastic part which connects the second base part and the stage part and which has elasticity for displacing the stage part along the another direction, and the applying part applies the microvibration for displacing the second base part such that the second base part resonates along the one direction at a resonance frequency determined by the first elastic part and a suspended part including the second base part and for displacing the stage part such that the stage part resonates along the another direction at a resonance frequency determined by the second elastic part and the stage part.

According to this aspect, the stage part is displaced along each of the one direction and the another direction by the elasticity of the elastic part (e.g. elasticity capable of displacing the stage part along the one direction and elasticity capable of displacing the stage part along the another direction). More specifically, the second base part can be displaced along the one direction using the elasticity of the first elastic part, and the stage part can be displaced along the another direction using the elasticity of the second elastic part. Here, since the stage part is connected to the second base part via the second elastic part, the displacement of the second base part along the one direction results in the displacement of the stage part along the one direction. In other words, the driving apparatus in this aspect can biaxially drive the stage part. Incidentally, it is obvious that multiaxial drive which is biaxial or more may be performed.

In this aspect, in particular, by the operation of the applying part, the microvibration is applied such that the second base part is displaced while resonating along the one direction at the resonance frequency determined by the first elastic part and the second base part (more specifically, the suspended part which is a structure including the second base part for suspending the stage part including the driven object and which is a structure composed of the stage part including the driven object, the second base part, and the second elastic part). More specifically, by the operation of the applying part, the microvibration is applied such that the second base part is displaced while resonating along the one direction at the resonance frequency determined by the mass of the second base part (more specifically, the suspended part which is a structure including the second base part for suspending the stage part including the driven object and which is a structure composed of the stage part including the driven object, the second base part, and the second elastic part) and a spring constant of the first elastic part. At the same time, the microvibration allows the stage part to be displaced while resonating along the another direction at the resonance frequency determined by the second elastic part and the stage part including the driven object. More specifically, the microvibration allows the stage part to be displaced while resonating along the another direction at the resonance frequency determined by the mass of the stage part including the driven object and a spring constant of the second elastic part. In other words, in this aspect, the microvibration for biaxially driving the stage part is applied from the same applying part (in other words, a single applying part).

Here, if the stage part is biaxially driven by applying a so-called directional force (e.g. if the base part is greatly vibrated along the displacement direction of the stage part and the vibration is directly applied to the elastic part and the stage part to drive the stage part), it is necessary to apply a directional force for displacing the stage part along the one direction (i.e. a directional force for greatly vibrating a structure such as the base part along the one direction) from one applying part. It is also necessary to apply a directional force for displacing the stage part along the another direction (i.e. a directional force for greatly vibrating a structure such as the base part along the another direction) from another applying part. That is, in the case where the biaxial drive of the stage part is performed by applying the directional force, usually, the driving apparatus needs to be provided with two or more applying parts (in other words, two or more driving sources). In other words, in the case where the biaxial drive of the stage part is performed by applying the directional force, because only a force that acts along the one direction can be applied from one applying part, and thus, the driving apparatus needs to be provided with two or more applying parts (i.e. two or more driving sources).

In the embodiment, however, the stage part can be biaxially driven by applying the non-directional force caused by the microvibration. Here, since the non-directional force caused by the microvibration is applied, the microvibration applied from one applying part allows the stage part to be displaced along each of the one direction and the another direction using the elasticity of the elastic part (i.e. the elasticity for displacing the stage part along the one direction and the elasticity for displacing the stage part along the another direction). In other words, in the embodiment, even in the case of the biaxial drive of the stage part, it is not always necessary to provide two applying parts. Thus, by using a single applying part (in other words, a single driving source), the microvibration for biaxially driving the stage part can be applied.

In addition, even if a force acting in two directions can be applied from one applying part, in the case where the biaxial drive of the stage part is performed by applying the directional force, it is eventually necessary to apply a force having components acting along the two directions (i.e. a directional component force for displacing the stage part along the one direction and a directional component force for displacing the stage part along the another direction). In this aspect, however, since the non-directional force caused by the microvibration is applied as the wave-energy, there is no need to apply the force in view of a direction of acting the force, which is also advantageous.

Incidentally, in the explanation described above, the suspended part which is a structure composed of the stage part, the second base part, and the second elastic part is explained as an example of the suspended part including the second base part. However, if other structures (e.g. magnetic poles, coils, comb-like (or interdigitated) electrodes, etc. described later) are provided for the second base part, the other structures also constitute the suspended part.

In this aspect, the applying part may apply, to the first base part, the microvibration for displacing the second base part such that the second base part resonates along the one direction at a resonance frequency determined by the first elastic part and the second base part and for displacing the stage part such that the stage part resonates along the another direction at a resonance frequency determined by the second elastic part and the stage part.

By virtue of such a configuration, the biaxial drive of the stage part can be preferably performed by applying the microvibration to the first base part.

In another aspect of the driving apparatus in the embodiment, the stage part is divided into a plurality of stage portions, the elastic part is provided with (i) a third elastic part which connects a first group of stage portions out of the plurality of stage portions and the base part and which has elasticity for displacing the first group of stage portions along at least one of the one direction and another direction which is different from the one direction and (ii) a fourth elastic part which connects a second group of stage portions, which is different from the first group of stage portions, out of the plurality of stage portions and the base part and which has elasticity for displacing the second group of stage portions along at least one of the one direction and the another direction, and the applying part applies the microvibration for displacing the first group of stage portions such that the first group of stage portions resonate along at least one of the one direction and the another direction at a resonance frequency determined by the third elastic part and the first group of stage portions and for displacing the second group of stage portions such that the second group of stage portions resonate along at least one of the one direction and the another direction at a resonance frequency determined by the fourth elastic part and the second group of stage portions.

According to this aspect, the stage part can be divided into the first group of stage portions which are displaced while resonating at one resonance frequency and the second group of stage portions which are displaced while resonating at another resonance frequency. Even in this case, since the non-directional force caused by the microvibration is applied, the microvibration allows the first group of stage portions to be displaced along at least one of the one direction and the another direction using the elasticity of the third elastic part and allows the second group of stage portions to be displaced along at least one of the one direction and the another direction using the elasticity of the fourth elastic part. Thus, even if the stage part is divided into the plurality of stage portions which are displaced while resonating at different resonance frequencies along different directions, each of the plurality of stage portions can be preferably displaced by using a single applying part.

In another aspect of the driving apparatus in the embodiment, the applying part is a single applying part.

According to this aspect, even in the case of the biaxial drive of the stage part, it is not always necessary to provide two applying parts. Thus, by using a single applying part, the microvibration for biaxially driving the stage part can be applied. Incidentally, it is obvious that multiaxial drive which is biaxial or more may be performed.

In another aspect of the driving apparatus in the embodiment, the elastic part has elasticity for displacing the stage part along another direction which is different from the one direction, and the applying part applies each of (i) a driving force for displacing the stage part such that the stage part is displaced along the one direction and (ii) the microvibration for displacing the stage part such that the stage part resonates along the another direction at a resonance frequency determined by the elastic part and the stage part, the microvibration being superimposed on the driving force.

According to this aspect, the elastic part has not only the elasticity for displacing the stage part along the one direction but also the elasticity for displacing the stage part along the another direction. The elastic part as described above may be realized, for example, by a first elastic part having the elasticity for displacing the stage part along the one direction and a second elastic part having the elasticity for displacing the stage part along the another direction. The elastic part as described above may be also realized, for example, by a single elastic part having both the elasticity for displacing the stage part along the one direction and the elasticity for displacing the stage part along the another direction. Thus, the stage part (more specifically, a structure for suspending the stage part and a structure composed of the stage part, the second base part, and the second elastic part detailed later) can be displaced along the one direction using the elasticity of the elastic part (more specifically, the first elastic part described later), and the stage part can be displaced along the another direction using the elasticity of the elastic part (more specifically, the second elastic part described later). Thus, as detailed later using the drawings, the biaxial drive of the stage can be preferably performed.

In this aspect, in particular, the stage part does not need to resonate along the one direction whereas the stage part resonates along the another direction when the stage part is displaced, which is different from the aspects of the driving apparatus described above in which the stage part resonates along each of the one direction and the another direction when the stage part is displaced. At this time, the applying part uses the non-directional force described above as a force for displacing the stage part along the another direction but does not need to use the non-directional force described above as a force for displacing the stage part along the one direction. In other words, the applying part may use the non-directional force described above as the force for displacing the stage part along the another direction and may use a directional force (i.e. a force directly acting along a direction of displacing the stage part along the one direction) as the force for displacing the stage part along the one direction. Even in such a configuration, the biaxial drive of the stage part can be preferably performed.

Moreover, the microvibration is applied in a state of being superimposed on the driving force. In other words, the applying part does not need to clearly distinguish the microvibration and the driving force before applying them.

In another aspect of the driving apparatus in the embodiment, the base part is provided with a first base part and a second base part which is surrounded by the first base part, the elastic part is provided with (i) a first elastic part which connects the first base part and the second base part and which has elasticity for displacing the second base part along the one direction and (ii) a second elastic part which connects the second base part and the stage part and which has elasticity for displacing the stage part along the another direction, and the applying part applies each of (i) a driving force for displacing the second base part such that the second base part is displaced along the one direction and (ii) the microvibration for displacing the stage part such that the stage part resonates along the another direction at a resonance frequency determined by the second elastic part and the stage part, the microvibration being superimposed on the driving force.

According to this aspect, the second base part can be displaced along the one direction using the elasticity of the first elastic part, and the stage part can be displaced along the another direction using the elasticity of the second elastic part. Here, since the stage part is connected to the second base part via the second elastic part, the displacement of the second base part along the one direction results in the displacement of the stage part along the one direction. Thus, as detailed later using the drawings, the biaxial drive of the stage part can be preferably performed.

In this aspect, in particular, the stage part does not need to resonate along the one direction whereas the stage part resonates along the another direction when the stage part is displaced, which is different from the aspects of the driving apparatus described above in which the stage part resonates along each of the one direction and the another direction when the stage part is displaced. At this time, the applying part uses the non-directional force described above as a force for displacing the stage part along the another direction but does not need to use the non-directional force described above as a force for displacing the stage part along the one direction. In other words, the applying part may use the non-directional force described above as the force for displacing the stage part along the another direction and may use a directional force (i.e. a force directly acting along a direction of displacing the stage part along the one direction) as the force for displacing the stage part along the one direction. Even in such a configuration, the biaxial drive of the stage part can be preferably performed.

In this aspect, the applying part may apply, to the second base part, each of (i) the driving force for displacing the second base part such that the second base part is displaced along the one direction and (ii) the microvibration for displacing the stage part such that the stage part resonates along the another direction at the resonance frequency determined by the second elastic part and the stage part, the microvibration being superimposed on the driving force.

By virtue of such a configuration, the biaxial drive of the stage part can be preferably performed by applying the microvibration and the driving force to the second base part.

These operation and other advantages in the embodiment will become more apparent from the examples explained below.

As explained above, according to the driving apparatus in the embodiment is provided with: the base part; the stage part; the elastic part; and the applying part. Therefore, it is possible to displace the stage part by using a force other than a directional force.

### EXAMPLES

Hereinafter, with reference to the drawings, examples of the driving apparatus will be explained. Incidentally, hereinafter, an explanation will be given to an example in which the driving apparatus is applied to a MEMS actuator.

### (1) First Example

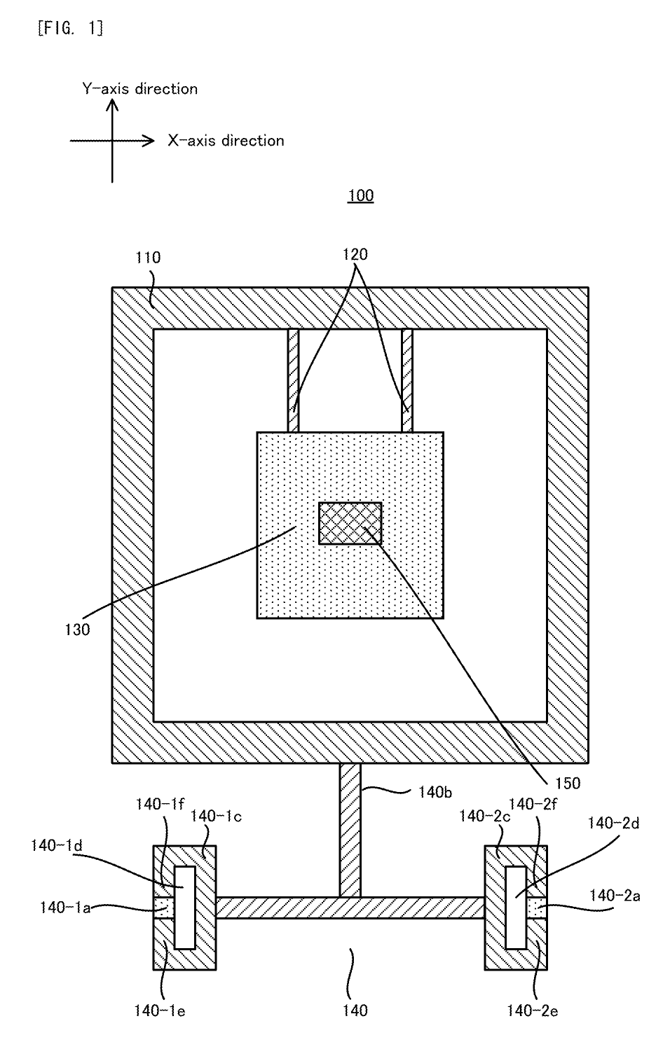

Firstly, with reference to FIG. 1 to FIG. 3, a first example of the MEMS actuator will be explained.

(1-1) Basic Configuration

Firstly, with reference to FIG. 1, a basic configuration of a MEMS actuator 100 in the first example will be explained. FIG. 1 is a plan view conceptually showing the basic configuration of the MEMS actuator 100 in the first example.

As shown in FIG. 1, the MEMS actuator 100 in the first example is provided with: a base 110 which constitutes one specific example of the “base part” described above; suspensions 120 which constitute one specific example of the “elastic part” described above; a stage 130 which constitutes one specific example of the “stage part” described above; and a driving source part 140 which constitutes one specific example of the “applying part” described above.

The base 110 has a frame shape with a space therein. In other words, the base 110 has a frame shape having two sides extending along a Y-axis direction in FIG. 1 and two sides extending along an X-axis direction (i.e. an axial direction perpendicular to the Y-axis) in FIG. 1 and having a space surrounded by the two sides extending along the Y-axis direction and the two sides extending along the X-axis direction. In an example shown in FIG. 1, the base 110 has, but not limited to, a square shape. For example, the base 110 may have another shape (e.g. rectangular shape such as an oblong, a circular shape, etc.). Moreover, the base 110 is a structure which is the foundation of the MEMS actuator 100 in the first example and is preferably fixed to a not-illustrated substrate or support member (in other words, is fixed in the inside of a system which is the MEMS actuator 100).

Incidentally, FIG. 1 shows the example in which the base 110 has the frame shape, but obviously the base 110 may have another shape. For example, the base 110 may have a U-shape in which one portion of the sides is open. Alternatively, for example, the base 110 may have a box shape with a space therein. In other words, the base 110 may have a box shape having two surfaces distributed on a plane defined by the X-axis and the Y-axis, two surfaces distributed on a plane defined by the X-axis and a not-illustrated Z-axis (i.e. an axis perpendicular to both the X-axis and the Y-axis), and two surfaces distributed on a plane defined by the Y-axis and the not-illustrated Z-axis, and having a space surrounded by the six surfaces. Alternatively, the shape of the base 110 may be arbitrarily changed depending on an arrangement aspect of the stage 130.

The suspension 120 is, for example, an elastic member such as a spring made of silicone, copper alloy, iron-based alloy, other metal, resin, or the like. The suspension 120 is connected to the base 110 at one end and connected to the stage 130 at the other end. Moreover, the suspension 120 has elasticity for displacing the stage 130 along the X-axis direction. In other words, the suspension 120 has a shape having elasticity for displacing the stage 130 along the X-axis direction. As the shape of the suspension 120, there is listed a shape having a long side extending along the Y-axis direction (in other words, a direction perpendicular to the direction for displacing the stage 130 (i.e. the X-axis)) and connecting the base 110 and the stage 130 at both ends of the long side. However, in accordance with a setting situation of a resonance frequency described later, the suspension 120 may have a shape having a short side extending along the Y-axis direction and a long side extending along the X-axis direction.

The stage 130 is a stage having a plate shape along a planar direction defined by the X-axis and the Y-axis. The shape of the stage 130, however, is not limited to this and may have an arbitrary shape. The stage 130 is disposed in the space in the inside of the base 110 so as to be hung or supported by the suspensions 120. The stage 130 is configured to be displaced (in other words, vibrated) along the X-axis direction by the elasticity of the suspensions 120.

Moreover, on the stage 130, a driven object 150 which is a drive target by the MEMS actuator 100 is mounted. As the driven object 150, for example, a recording/reproducing head (or a recording/reproducing probe) of an information recording/reproducing apparatus, a recording medium which is targeted for the recording/reproducing operation of the information recording/reproducing apparatus, a scan sample of a scanning microscope, and the like are listed as one example.

The driving source part 140 applies, to the base 110, microvibration required to displace the stage 130 along the X-axis direction. Incidentally, as long as the driving source part 140 can apply the microvibration to the base 110, its arrangement aspect may be determined arbitrarily. Moreover, it may be configured not only to apply the microvibration to the base 110 but also to apply the microvibration to other positions.

More specifically, the driving source part 140 is provided with: a first piezoelectric element 140-1a; a second piezoelectric element 140-2a; a transmission branch 140b; a first support plate 140-1c having a first space 140-1d and fixed to the base 110 via the transmission branch 140b; and a second support plate 140-2c having a second space 140-2d and fixed to the base 110 via the transmission branch 140b. On the first support plate 140-1c, the first piezoelectric element 140-1a is sandwiched between first branches 140-1e and 140-1f facing to each other and defined by the first space 140-1d. On the second support plate 140-2c, the second piezoelectric element 140-2a is sandwiched between second branches 140-2e and 140-2f facing to each other and defined by the second space 140-2d. The application of a voltage to the first piezoelectric element 140-1a via a not-illustrated electrode changes the shape of the first piezoelectric element 140-1a. The change in the shape of the first piezoelectric element 140-1a causes a change in the shapes of the first branches 140-1e and 140-1f. As a result, the change in the shapes of the first branches 140-1e and 140-1f is transmitted to the base 110 via the transmission branch 140b as the microvibration (or wave-energy) detailed later. In the same manner, the application of a voltage to the second piezoelectric element 140-2a via a not-illustrated electrode changes the shape of the second piezoelectric element 140-2a. The change in the shape of the second piezoelectric element 140-2a causes a change in the shapes of the second branches 140-2e and 140-2f. As a result, the change in the shapes of the second branches 140-2e and 140-2f is transmitted to the base 110 via the transmission branch 140b as the microvibration (or the wave-energy) detailed later.

Incidentally, as the driving source part 140, not only a driving source part for applying microvibration caused by a piezoelectric effect, but also a driving source part for applying microvibration caused by an electromagnetic force and a driving source part for applying microvibration caused by an electrostatic force may be used. Of course, other methods may be also used.

For example, the driving source part for applying the microvibration caused by the electromagnetic force is provided with: magnetic poles disposed in the first branch 140-1e and the second branch 140-2e; and coils disposed in the first branch 140-1f and the second branch 140-2f. In this case, a desired voltage is applied to the coils in desired timing from a not-illustrated driving source part control circuit. The application of the voltage to the coils causes an electric current to flow and causes an electromagnetic interaction between the coils and the magnetic poles. As a result, an electromagnetic force is generated by the electromagnetic interaction. The electromagnetic force causes the change in the shapes of the first branches 140-1e and 140-1f and the second branches 140-2e and 140-2f. As a result, the change in the shapes of the first branches 140-1e and 140-1f and the second branches 140-2e and 140-2f is transmitted to the base 110 via the transmission branch 140b as the microvibration (or the wave-energy) detailed later.

Moreover, the driving source part for applying the microvibration caused by the electrostatic force is provided with: first comb-like (or interdigitated) electrodes disposed in the first branch 140-1e and the second branch 140-2e; and second comb-like (or interdigitated) electrodes disposed in the first branch 140-1f and the second branch 140-2f and distributed in such a manner that the first electrodes and the second electrodes interdigitate each other. In this case, a desired voltage is applied to the first electrodes in desired timing from a not-illustrated driving source part control circuit. Due to a potential difference between the first electrodes and the second electrodes, an electrostatic force (in other words, Coulomb force) is generated between the first electrodes and the second electrodes. The electrostatic force causes the change in the shapes of the first branches 140-1e and 140-1f and the second branches 140-2e and 140-2f. As a result, the change in the shapes of the first branches 140-1e and 140-1f and the second branches 140-2e and 140-2f is transmitted to the base 110 via the transmission branch 140b as the microvibration (or the wave-energy) detailed later.

(1-2) Operation of MEMS Actuator

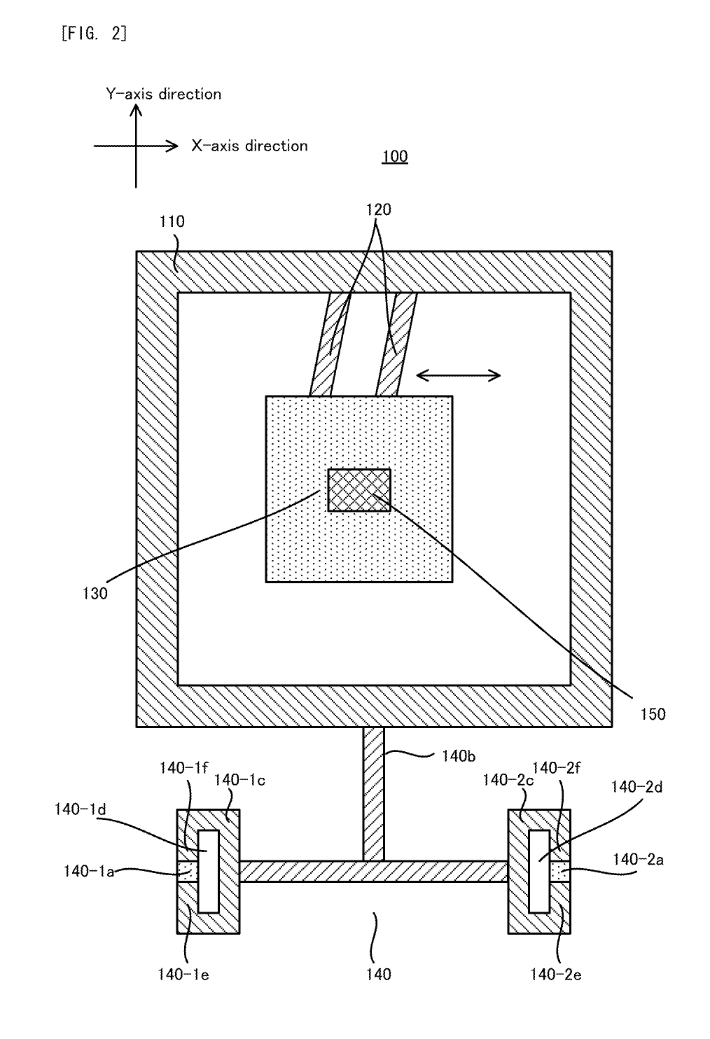

Next, with reference to FIG. 2, an explanation will be given to an aspect of the operation of the MEMS actuator 100 in the first example (specifically, an aspect of the operation of displacing the stage 130). FIG. 2 is a plan view conceptually showing the aspect of the operation performed by the MEMS actuator 100 in the first example.

In operation of the MEMS actuator 100 in the first example, the driving source part 140 applies a voltage to the first piezoelectric element 140-1a and the second piezoelectric element 140-2a via a not-illustrated electrode such that the first piezoelectric element 140-1a and the second piezoelectric element 140-2a expand and contract along the Y-axis direction in FIG. 2. This changes the shapes of the first piezoelectric element 140-1a and the second piezoelectric element 140-2a and changes the shapes of the first branches 140-1e and 140-1f and the second branches 140-2e and 140-2f. As a result, the change in the shapes of the first branches 140-1e and 140-1f and the second branches 140-2e and 140-2f is transmitted to the base 110 via the transmission branch 140b as the microvibration (or the wave-energy) detailed later.

Here, since the change in the shapes of the first piezoelectric element 140-1a and the second piezoelectric element 140-2a is along the Y-axis direction in FIG. 2, the change in the shape of each of the first branches 140-1e and 140-1f and the second branches 140-2e and 140-2f caused by the change in the shapes of the first piezoelectric element 140-1a and the second piezoelectric element 140-2a occurs along the Y-axis direction in FIG. 2. The change in the shapes of the first piezoelectric element 140-1a and the second piezoelectric element 140-2a (i.e. the change in the shape of each of the first branches 140-1e and 140-1f and the second branches 140-2e and 140-2f) is transmitted to the base 110 as the microvibration (in other words, the wave-energy and a non-directional force) via the first support plate 140-1c and the second support plate 140-2c and the transmission branch 140b. More specifically, the driving source part 140 applies the microvibration, which is propagated in the inside of the base 110, as the wave-energy to the base 110 which is the foundation. In other words, the driving source part 140 applies the microvibration which is propagated as energy (in other words, as energy for developing a force) in the inside of the base 110. The microvibration becomes the non-directional force when being propagated in the inside of the base 110. In other words, the wave-energy propagated in the inside of the base 110 as the microvibration is propagated along an arbitrary direction in the inside of the base 110. Moreover, the base 110 to which the microvibration is applied becomes a medium for propagating the microvibration (in other words, pulsed energy) rather than an object in which the base 110 vibrates.

As a result, the microvibration applied from the driving source part 140 to the base 110 is transmitted from the base 110 to the suspensions 120. Then, as shown in FIG. 2, the microvibration (in other words, the wave-energy) propagated in the inside of the base 110 vibrates the suspensions 120 along a direction according to the elasticity of the suspensions 120 and vibrates the stage 130. In other words, the microvibration propagated in the inside of the base 110 appears as the vibration of the suspensions 120 and the vibration of the stage 130. In other words, the wave-energy can be extracted as vibration along all directions without limiting the direction of the microvibration. In other words, the wave-energy propagated in the inside of the base 110 can be extracted to the exterior in a form of vibration (more specifically, resonance), resulting in the displacement of the stage 130. As a result, as shown in FIG. 2, the stage 130 is displaced along the X-axis direction.

At this time, the stage 130 is displaced so as to resonate at a resonance frequency determined in accordance with the stage 130 (i.e. the stage 130 including the driven object 150 mounted thereon) and the suspensions 120. For example, if the mass of the stage 130 including the driven object 150 is m and a spring constant of the suspensions 120 when the suspensions 120 are regarded as one spring is k, the stage 130 is displaced along the X-axis direction so as to resonate at a resonance frequency specified by (1/(2π))×√(k/m) (or a resonance frequency which is N multiple or 1/N multiple of (1/(2π))×√(k/m) (where N is an integral number of 1 or more)). Thus, the driving source part 140 applies the microvibration in an aspect of being synchronized with the resonance frequency such that the stage 130 resonates at the resonance frequency.

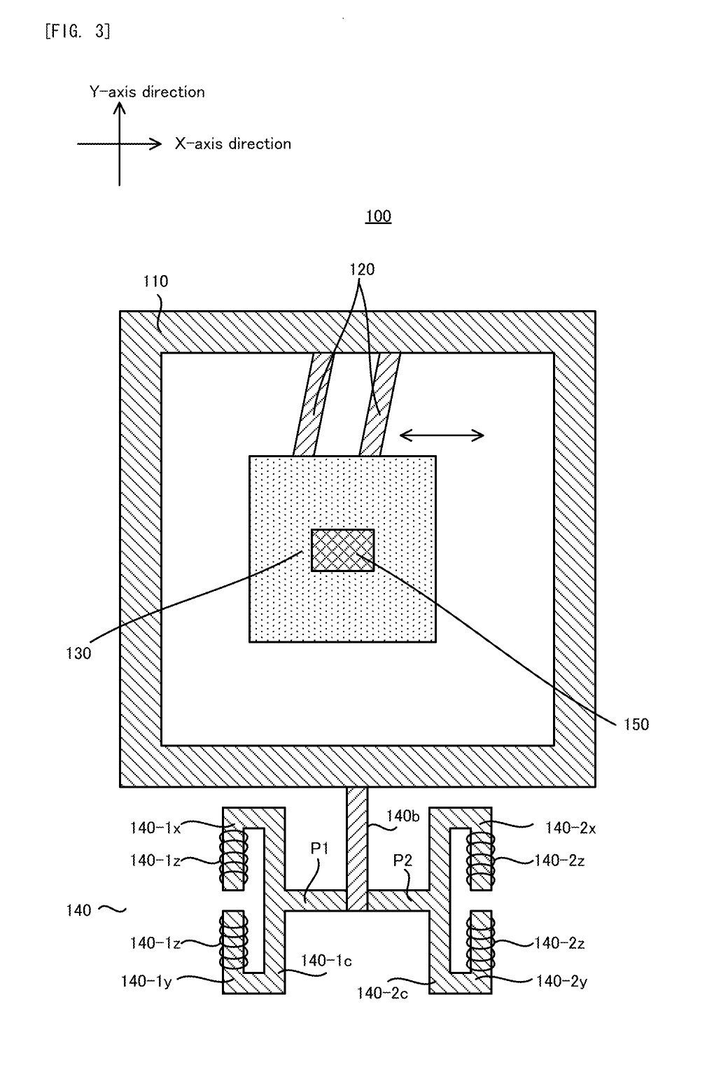

Now, with reference to FIG. 3, the non-directional force caused by the microvibration applied from the driving source part 140 will be further explained. FIG. 3 is a plan view for explaining the non-directional force caused by the microvibration applied from the driving source part 140. Incidentally, the following explanation uses a configuration in which the driving force part 140 applies the microvibration caused by the electromagnetic force.

As shown in FIG. 3, the driving source part 140 is provided with: the transmission branch 140b; the first support plate 140-1c connected to the base 110 via the transmission branch 140b and provided with first branches 140-1x and 140-1y facing to each other along the Y-axis direction; the second support plate 140-2c connected to the base 110 via the transmission branch 140b and provided with second branches 140-2x and 140-2y facing to each other along the Y-axis direction; first coils 140-1z which are wound around the first branches 140-1x and 140-1y; and second coils 140-2z which are wound around the second branches 140-2x and 140-2y. Moreover, it is assumed that the first branches 140-1x and 140-1y and the second branches 140-2x and 140-2y have the same shape and characteristics, that the characteristics (e.g. the number of turns) of the coil 140-1z which is wound around the first branch 140-1x are the same as the characteristics (e.g. the number of turns) of the coil 140-1z which is wound around the first branch 140-1y, and that the characteristics (e.g. the number of turns) of the coil 140-2z which is wound around the second branch 140-2x are the same as the characteristics (e.g. the number of turns) of the coil 140-2z which is wound around the second branch 140-2y.

Here, in a case where an electric current is applied to the coils 140-1z and 140-2z which are wound around the first branches 140-1x and 140-1y and the second branches 140-2x and 140-2y, respectively, if a force to be pulled toward the direction of the first branch 140-1y and the second branch 140-2y (i.e. a force acting toward a negative direction of the Y-axis, i.e. a downward side in FIG. 3) is generated for the first branch 140-1x and the second branch 140-2x due to the electromagnetic interaction, a force to be pulled toward the direction of the first branch 140-1x and the second branch 140-2x (i.e. a force acting toward a positive direction of the Y-axis, i.e., an upward side in FIG. 3) is also generated for the first branch 140-1y and the second branch 140-2y. The forces are opposed to each other and have the same magnitude. The forces thus do not cause acceleration in the exterior and thereon, and only the microvibration is transmitted to a point P1 of the junction of the first branch 140-1x and the first branch 140-1y (in other words, a point P1 on the transmission branch 140b) and a point P2 of the junction of the second branch 140-2x and the second branch 140-2y (in other words, a point P2 on the transmission branch 140b). As a result, forces at the points P1 and P2 are not directional. In the same manner, if a force to be separated from the first branch 140-1y and the second branch 140-2y (i.e. a force acting toward the positive direction of the Y-axis, i.e., the upward side in FIG. 3) is generated for the first branch 140-1x and the second branch 140-2x due to the electromagnetic interaction, a force to be separated from the first branch 140-1x and the second branch 140-2x (i.e. a force acting toward the negative direction of the Y-axis, i.e., the downward side in FIG. 3) is also generated for the first branch 140-1y and the second branch 140-2y. The forces are opposed to each other and have the same magnitude. The forces thus do not cause acceleration in the exterior and thereon, and only the microvibration is transmitted to the point P1 of the junction of the first branch 140-1x and the first branch 140-1y and the point P2 of the junction of the second branch 140-2x and the second branch 140-2y. As a result, forces at the points P1 and P2 are not directional.

However, according to experiments of the present inventors, it has been found that the microvibration (i.e. the pulsed energy and the non-directional force) is propagated in the inside of the base 110 due to the aforementioned configuration, resulting in the displacement of the stage 130 along the X-axis direction. In other words, it has been found that the microvibration applied by the driving source part 140 is propagated in the inside of the base 110 as the non-directional force (in other words, the wave-energy) described above, by which the stage 130 is displaced along the X-axis direction. In other words, it has been found that the microvibration applied by the driving source part 140 is uncorrelated with a displacement direction of the stage 130.

As described above, in the first example, the stage 130 can be displaced such that the stage 130 resonates along the X-axis direction at the resonance frequency determined in accordance with the stage 130 and the suspensions 120. In other words, in the first example, the stage 130 self-resonates along the X-axis direction.

Here, the “resonance” is a phenomenon in which the repetition of an infinitesimal force causes infinite displacement. Thus, even in the case of a small force to be applied to displace the stage 130, a displacement range of the stage 130 (in other words, an amplitude along the displacement direction) can be set large. In other words, it is possible to set a force required to displace the stage 130 relatively small. It is thus possible to reduce the amount of electric power necessary to apply the force required to displace the stage 130. Therefore, it is possible to displace the stage 130 more efficiently, resulting in lower power consumption of the MEMS actuator 100.

In addition, in the first example, the non-directional force is applied.

Here, as a comparative example, a configuration in which the stage 130 is driven by applying a so-called directional force (e.g. a configuration in which the base 110 is greatly vibrated along the displacement direction of the stage 130 and the vibration is directly applied to the suspensions 120 and the stage 130 to drive the stage 130) will be explained. In this case, it is necessary to apply a directional force for displacing the stage 130 along the X-axis direction (i.e. a directional force for greatly vibrating the base 110 along the X-axis direction) from the driving source part 140. Thus, the placement position of the driving source part 140 needs to be appropriately set such that the directional force can be applied. In other words, if the directional force is applied, the placement position of the driving source part 140 is limited depending on a direction of acting the force.

In the first example, however, since the non-directional force caused by the microvibration is applied, the placement position of the driving source part 140 is no longer limited. In other words, the application of the non-directional force caused by the microvibration does not cause such a situation that the placement position of the driving source part 140 is limited depending on the displacement direction of the stage 130. That is, regardless of the placement position of the driving source part 140, the microvibration (i.e. the non-directional force) applied from the driving source part 140 allows the stage 130 to be displaced along the X-axis direction using the elasticity of the suspensions 120. This makes it possible to relatively increase the degree of freedom in the design of the MEMS actuator 100. This is extremely useful in practice for the MEMS actuator which is significantly limited in size or design of each constituent.

In addition, in the first example, since the non-directional force caused by the microvibration (i.e. the non-directional microvibration) is applied, it is not necessary to apply the microvibration in view of a direction of the actual vibration of the stage 130. In other words, it is not necessary to apply a force directly acting along a direction matching the direction of the actual vibration of the stage 130. More specifically, as shown in FIG. 3, although a force generated by the first piezoelectric element 140-1a and the second piezoelectric element 140-2a provided for the driving source part 140 acts along the Y-axis direction in FIG. 3, the stage 130 can be displaced along the X-axis direction. In other words, it is not necessary to generate the force acting along the X-axis direction in FIG. 3 using the first piezoelectric element 140-1a and the second piezoelectric element 140-2a provided for the driving source part 140 in order to displace the stage 130 along the X-axis direction. Thus, regardless of where the driving source part 140 is disposed, the stage 130 can be preferably displaced along a desired direction.

### (2) Second Example

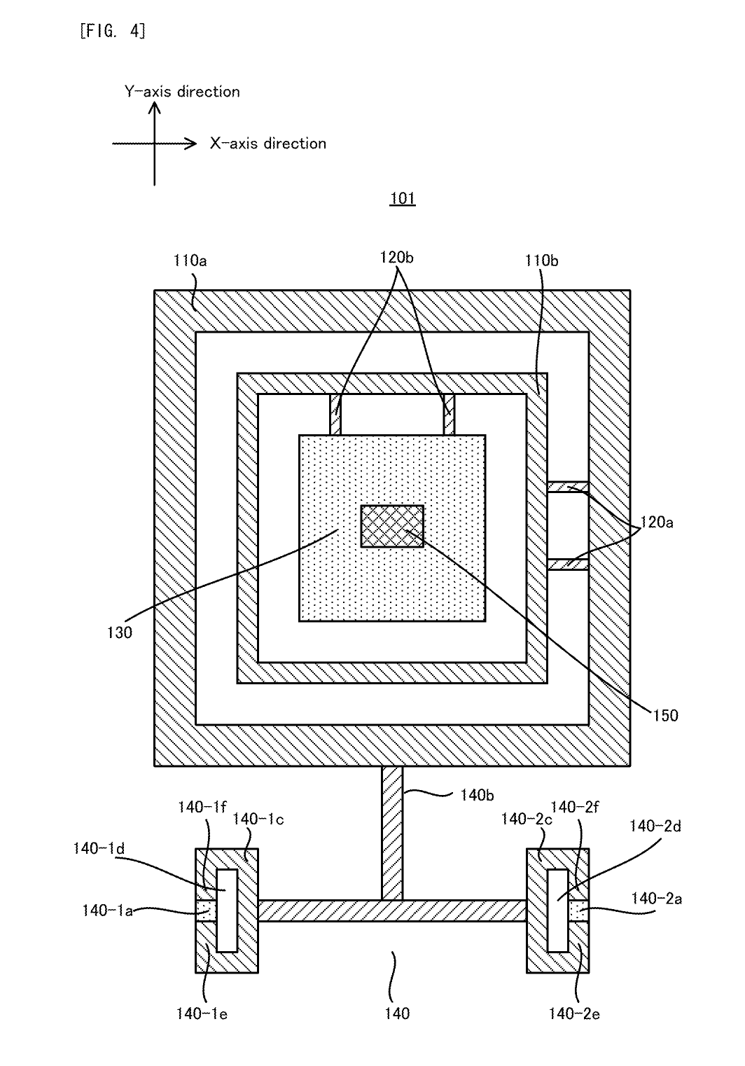

Next, with reference to FIG. 4 to FIG. 6, a second example of the MEMS actuator will be explained.

(2-1) Basic Configuration

Firstly, with reference to FIG. 4, a basic configuration of a MEMS actuator 101 in the second example will be explained. FIG. 4 is a plan view conceptually showing the basic configuration of the MEMS actuator 101 in the second example.

As shown in FIG. 4, the MEMS actuator 101 in the second example is provided with: a first base 110a which constitutes one specific example of the “base part (or first base part)” described above; first suspensions 120a which constitutes one specific example of the “elastic part (or first elastic part)” described above; a second base 110b which constitutes one specific example of the “base part (or second base part)” described above; second suspensions 120b which constitutes one specific example of the “elastic part (or second elastic part)” described above; a stage 130 which constitutes one specific example of the “stage part” described above; and a driving source part 140 which constitutes one specific example of the “applying part” described above.

The first base 110a has a frame shape with a space therein. In other words, the first base 110a has a frame shape having two sides extending along the Y-axis direction in FIG. 4 and two sides extending along the X-axis direction (i.e. an axial direction perpendicular to the Y-axis) in FIG. 4 and having a space surrounded by the two sides extending along the Y-axis direction and the two sides extending along the X-axis direction. In an example shown in FIG. 4, the first base 110a has, but not limited to, a square shape. For example, the first base 110a may have another shape (e.g. rectangular shape such as an oblong, a circular shape, etc.). Moreover, the first base 110a is a structure which is the foundation of the MEMS actuator 101 in the second example and is preferably fixed to a not-illustrated substrate or support member (in other words, is fixed in the inside of a system which is the MEMS actuator 101).

Incidentally, FIG. 4 shows the example in which the first base 110a has the frame shape, but obviously the first base 110a may have another shape. For example, the first base 110a may have a U-shape in which one portion of the sides is open. Alternatively, for example, the first base 110a may have a box shape with a space therein. In other words, the first base 110a may have a box shape having two surfaces distributed on a plane defined by the X-axis and the Y-axis, two surfaces distributed on a plane defined by the X-axis and a not-illustrated Z-axis (i.e. an axis perpendicular to both the X-axis and the Y-axis), and two surfaces distributed on a plane defined by the Y-axis and the not-illustrated Z-axis, and having a space surrounded by the six surfaces. Alternatively, the shape of the first base 110a may be arbitrarily changed depending on an arrangement aspect of the stage 130.

The first suspension 120a is, for example, an elastic member such as a spring made of silicone, copper alloy, iron-based alloy, other metal, resin, or the like. The first suspension 120a is connected to the first base 110a at one end and connected to the second base 110b at the other end. Moreover, the first suspension 120a has elasticity for displacing the second base 110b along the Y-axis direction. In other words, the first suspension 120a has a shape having elasticity for displacing the second base 110b along the Y-axis direction. As the shape of the first suspension 120a, a shape having a long side extending along the X-axis direction (in other words, a direction perpendicular to the direction for displacing the second base 110b (i.e. the Y-axis)) and connecting the first base 110a and the second base 110b at both ends of the long side. However, in accordance with a setting situation of a resonance frequency described later, the first suspension 120a may have a shape having a short side extending along the X-axis direction and a long side extending along the Y-axis direction.

The second base 110b has a frame shape with a space therein. In other words, the second base 110b has a frame shape having two sides extending along the Y-axis direction in FIG. 4 and two sides extending along the X-axis direction (i.e. an axial direction perpendicular to the Y-axis) in FIG. 4 and having a space surrounded by the two sides extending along the Y-axis direction and the two sides extending along the X-axis direction. In the example shown in FIG. 4, the second base 110b has, but not limited to, a square shape. For example, the second base 110b may have another shape (e.g. rectangular shape such as an oblong, a circular shape, etc.). In other words, the second base 110b can adopt an arbitrary shape as in the shape of the first base 110a.

The second base 110b is disposed in the space in the inside of the first base 110a so as to be hung or supported by the first suspensions 120a. The second base 110b is configured to be displaced (in other words, vibrated) along the Y-axis direction by the elasticity of the first suspensions 120a.

The second suspension 120b is, for example, an elastic member such as a spring made of silicone, copper alloy, iron-based alloy, other metal, resin, or the like. The second suspension 120b is connected to the second base 110b at one end and connected to the stage 130 at the other end. Moreover, the second suspension 120b has elasticity for displacing the stage 130 along the X-axis direction. In other words, the second suspension 120b has a shape having elasticity for displacing the stage 130 along the X-axis direction. As the shape of the second suspension 120b, a shape having a long side extending along the Y-axis direction (in other words, a direction perpendicular to the direction for displacing the stage 130 (i.e. the X-axis)) and connecting the second base 110b and the stage 130 at both ends of the long side. However, in accordance with the setting situation of the resonance frequency described later, the second suspension 120b may have a shape having a short side extending along the Y-axis direction and a long side extending along the X-axis direction.

The stage 130 is a stage having a plate shape along a planar direction defined by the X-axis and the Y-axis. The shape of the stage 130, however, is not limited to this and may have an arbitrary shape. The stage 130 is disposed in the space in the inside of the second base 110b so as to be hung or supported by the second suspensions 120b. The stage 130 is configured to be displaced (in other words, vibrated) along the X-axis direction by the elasticity of the second suspensions 120b.

Moreover, on the stage 130, a driven object 150 which is a drive target by the MEMS actuator 101 is mounted. As the driven object 150, for example, a recording/reproducing head (or a recording/reproducing probe) of an information recording/reproducing apparatus, a recording medium which is targeted for the recording/reproducing operation of the information recording/reproducing apparatus, a scan sample of a scanning microscope, and the like are listed as one example.

The driving source part 140 applies, to the first base 110a, microvibration required to displace the second base 110b along the Y-axis direction and to displace the stage 130 along the X-axis direction. Incidentally, as long as the driving source part 140 can apply the microvibration to the first base 110a, its arrangement aspect may be determined arbitrarily. Moreover, it may be configured not only to apply the microvibration to the first base 110a but also to apply the microvibration to other positions.

More specifically, the driving source part 140 is provided with: a first piezoelectric element 140-1a; a second piezoelectric element 140-2a; a transmission branch 140b; a first support plate 140-1c having a first space 140-1d and fixed to the first base 110a via the transmission branch 140b; and a second support plate 140-2c having a second space 140-2d and fixed to the first base 110a via the transmission branch 140b. On the first support plate 140-1c, the first piezoelectric element 140-1a is sandwiched between first branches 140-1e and 140-1f facing to each other and defined by the first space 140-1d. On the second support plate 140-2c, the second piezoelectric element 140-2a is sandwiched between second branches 140-2e and 140-2f facing to each other and defined by the second gap 140-2d. The application of a voltage to the first piezoelectric element 140-1a via a not-illustrated electrode changes the shape of the first piezoelectric element 140-1a. The change in the shape of the first piezoelectric element 140-1a causes a change in the shapes of the first branches 140-1e and 140-1f. As a result, the change in the shapes of the first branches 140-1e and 140-1f is transmitted to the first base 110a via the transmission branch 140b as the microvibration (or the wave-energy) detailed later. In the same manner, the application of a voltage to the second piezoelectric element 140-2a via a not-illustrated electrode changes the shape of the second piezoelectric element 140-2a. The change in the shape of the second piezoelectric element 140-2a causes a change in the shapes of the second branches 140-2e and 140-2f. As a result, the change in the shapes of the second branches 140-2e and 140-2f is transmitted to the first base 110a via the transmission branch 140b as the microvibration (or the wave-energy) detailed later.

Incidentally, as the driving source part 140, not only a driving source part for applying microvibration caused by a piezoelectric effect, but also a driving source part for applying microvibration caused by an electromagnetic force and a driving source part for applying microvibration caused by an electrostatic force may be used. Of course, other methods may be also used.

For example, the driving source part for applying the microvibration caused by the electromagnetic force is provided with: magnetic poles disposed in the first branch 140-1e and the second branch 140-2e; and coils disposed in the first branch 140-1f and the second branch 140-2f. In this case, a desired voltage is applied to the coils in desired timing from a not-illustrated driving source part control circuit. The application of the voltage to the coils causes an electric current to flow and causes an electromagnetic interaction between the coils and the magnetic poles. As a result, an electromagnetic force is generated by the electromagnetic interaction. The electromagnetic force causes the change in the shapes of the first branches 140-1e and 140-1f and the second branches 140-2e and 140-2f. As a result, the change in the shapes of the first branches 140-1e and 140-1f and the second branches 140-2e and 140-2f is transmitted to the first base 110a via the transmission branch 140b as the microvibration (or pulsed energy) detailed later.

Moreover, the driving source part for applying the microvibration caused by the electrostatic force is provided with: first comb-like (or interdigitated) electrodes disposed in the first branch 140-1e and the second branch 140-2e; and second comb-like (or interdigitated) electrodes disposed in the first branch 140-1f and the second branch 140-2f and distributed in such a manner that the first electrodes and the second electrodes interdigitate each other. In this case, a desired voltage is applied to the first electrodes in desired timing from a not-illustrated driving source part control circuit. Due to a potential difference between the first electrodes and the second electrodes, an electrostatic force (in other words, Coulomb force) is generated between the first electrodes and the second electrodes. The electrostatic force causes the change in the shapes of the first branches 140-1e and 140-1f and the second branches 140-2e and 140-2f. As a result, the change in the shapes of the first branches 140-1e and 140-1f and the second branches 140-2e and 140-2f is transmitted to the first base 110a via the transmission branch 140b as the microvibration (or pulsed energy) detailed later.

(2-2) Operation of MEMS Actuator

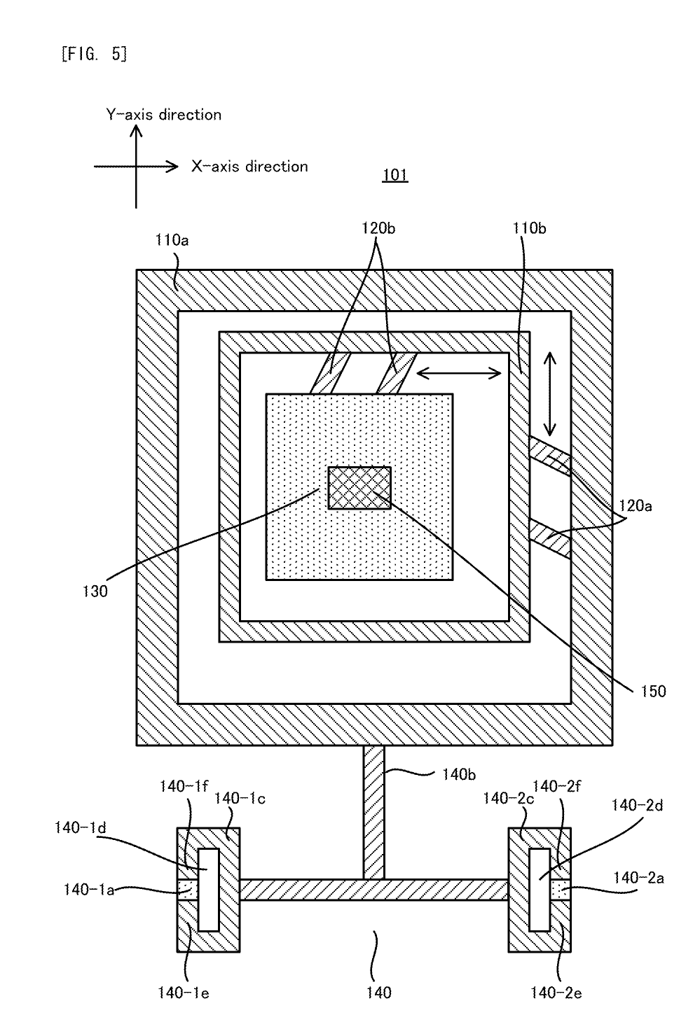

Next, with reference to FIG. 5, an explanation will be given to an aspect of the operation of the MEMS actuator 101 in the second example (specifically, an aspect of the operation of displacing the stage 130). FIG. 5 is a plan view conceptually showing the aspect of the operation performed by the MEMS actuator 101 in the second example.

In operation of the MEMS actuator 101 in the second example, the driving source part 140 applies a voltage to the first piezoelectric element 140-1a and the second piezoelectric element 140-2a via a not-illustrated electrode such that the first piezoelectric element 140-1a and the second piezoelectric element 140-2a expand and contract along the Y-axis direction in FIG. 5. This changes the shapes of the first piezoelectric element 140-1a and the second piezoelectric element 140-2a and changes the shapes of the first branches 140-1e and 140-1f and the second branches 140-2e and 140-2f. As a result, the change in the shapes of the first branches 140-1e and 140-1f and the second branches 140-2e and 140-2f is transmitted to the first base 110a via the transmission branch 140b as the microvibration (or pulsed energy) detailed later.

Here, since the change in the shapes of the first piezoelectric element 140-1a and the second piezoelectric element 140-2a is along the Y-axis direction in FIG. 5, the change in the shape of each of the first branches 140-1e and 140-1f and the second branches 140-2e and 140-2f caused by the change in the shapes of the first piezoelectric element 140-1a and the second piezoelectric element 140-2a occurs along the Y-axis direction in FIG. 5. The change in the shapes of the first piezoelectric element 140-1a and the second piezoelectric element 140-2a (i.e. the change in the shape of each of the first branches 140-1e and 140-1f and the second branches 140-2e and 140-2f) is transmitted to the first base 110a as the microvibration (in other words, wave-energy and a non-directional force) via the first support plate 140-1c and the second support plate 140-2c and the transmission branch 140b. More specifically, the driving source part 140 applies the microvibration, which is propagated in the inside of the first base 110a, as the pulsed energy to the first base 110a which is the foundation. In other words, the driving source part 140 applies the microvibration which is propagated as energy (in other words, as energy for developing a force) in the inside of the first base 110a. The microvibration becomes the non-directional force when being propagated in the inside of the first base 110a. In other words, the wave-energy propagated in the inside of the first base 110a as the microvibration is propagated along an arbitrary direction in the inside of the first base 110a. Moreover, the first base 110a to which the microvibration is applied becomes a medium for propagating the microvibration (in other words, pulsed energy) rather than an object in which the first base 110a vibrates.

As a result, the microvibration applied from the driving source part 140 to the first base 110a is transmitted from the first base 110a to the first suspensions 120a. Then, as shown in FIG. 5, the microvibration (in other words, pulsed energy) propagated in the inside of the first base 110a vibrates the first suspensions 120a along a direction according to the elasticity of the first suspensions 120a and vibrates the second base 110b. In other words, the microvibration propagated in the inside of the first base 110a appears as the vibration of the first suspensions 120a and the vibration of the second base 110b. In other words, the wave-energy can be extracted as vibration along all directions without limiting the direction of the microvibration. In other words, the wave-energy propagated in the inside of the first base 110a can be extracted to the exterior in a form of vibration (more specifically, resonance), resulting in the displacement of the second base 110b for supporting the stage 130. As a result, as shown in FIG. 5, the second base 110b is displaced along the Y-axis direction.

At this time, the second base 110b is displaced so as to resonate at a resonance frequency determined in accordance with the second base 110b (i.e. a suspended part including the second base 110b suspended by the first suspensions 120a) and the first suspensions 120a. For example, if the mass of the suspended part including the second base 110b (more specifically, the mass of the suspended part composed of an entire system which is the second base 110b, to which the mass of each of the stage 130 including the driven object 150 and the second suspensions 120b provided in the second base 110b is added) is m1 and a spring constant of the first suspensions 120a when the first suspensions 120a are regarded as one spring is k1, the second base 110b is displaced along the Y-axis direction so as to resonate at a resonance frequency specified by (1/(2π))×√(k1/m1) (or a resonance frequency which is N multiple or 1/N multiple of (1/(2π))×√(k1/m1) (where N is an integral number of 1 or more)). Thus, the driving source part 140 applies the microvibration in an aspect of being synchronized with the resonance frequency such that the second base 110b resonates at the resonance frequency.

In the same manner, the microvibration applied from the driving source part 140 to the first base 110a is transmitted from the first base 110a via the first suspensions 120a and the second base 110b to the second suspensions 120b. Then, as shown in FIG. 5, the microvibration (in other words, the wave-energy) propagated in the inside of the first base 110a vibrates the second suspensions 120b along a direction according to the elasticity of the second suspensions 120b and vibrates the stage 130. In other words, the microvibration propagated in the inside of the first base 110a appears as the vibration of the second suspensions 120b and the vibration of the stage 130. In other words, the wave-energy can be extracted as vibration along all directions without limiting the direction of the microvibration. In other words, the wave-energy propagated in the inside of the first base 110a and the second base 110b can be extracted to the exterior in a form of vibration (more specifically, resonance), resulting in the displacement of the stage 130. As a result, as shown in FIG. 5, the stage 130 is displaced along the X-axis direction.

At this time, the stage 130 is displaced so as to resonate at a resonance frequency determined in accordance with the stage 130 including the driven object 150 and the second suspensions 120b. For example, if the mass of the stage 130 including the driven object 150 is m2 and a spring constant of the second suspensions 120b when the second suspensions 120b are regarded as one spring is k2, the stage 130 is displaced along the X-axis direction so as to resonate at a resonance frequency specified by (1/(2π))×√(k2/m2) (or a resonance frequency which is N multiple or 1/N multiple of (1/(2π))×√(k2/m2) (where N is an integral number of 1 or more)). Thus, the driving source part 140 applies the microvibration in an aspect of being synchronized with the resonance frequency such that the stage 130 resonates at the resonance frequency.

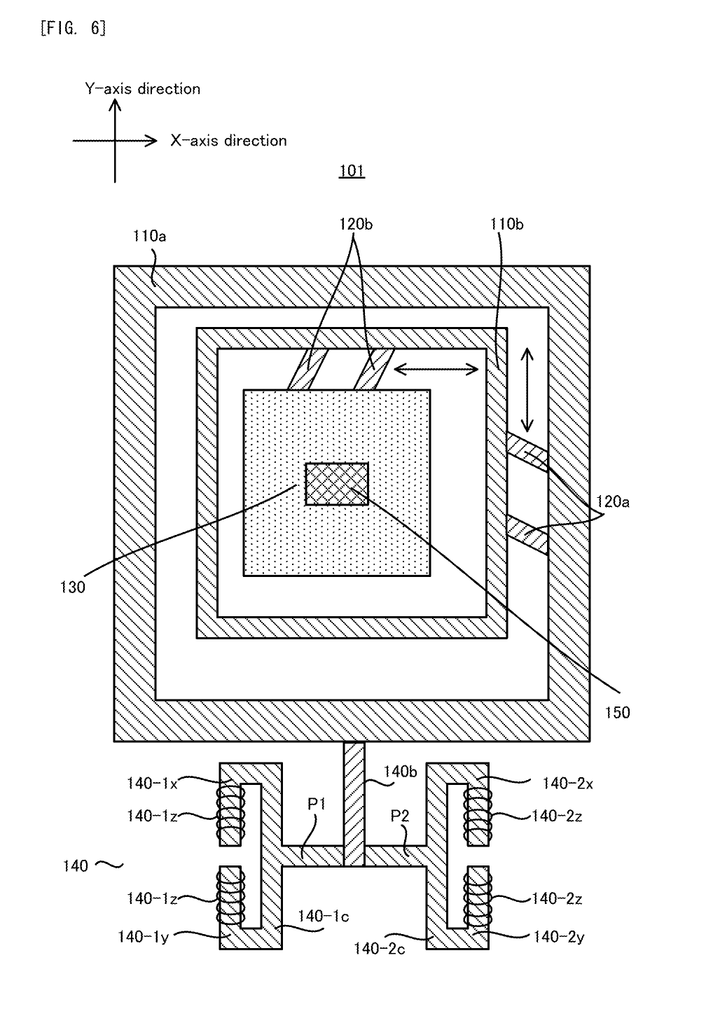

Now, with reference to FIG. 6, the non-directional force caused by the microvibration applied from the driving source part 140 will be further explained. FIG. 6 is a plan view for explaining the non-directional force caused by the microvibration applied from the driving source part 140. Incidentally, the following explanation uses a configuration in which the driving force part 140 applies the microvibration caused by the electromagnetic force.

As shown in FIG. 6, the driving source part 140 is provided with: the transmission branch 140b; the first support plate 140-1c connected to a first base 110a via the transmission branch 140b and provided with first branches 140-1x and 140-1y facing to each other along the Y-axis direction; the second support plate 140-2c connected to the first base 110a via the transmission branch 140b and provided with second branches 140-2x and 140-2y facing to each other along the Y-axis direction; first coils 140-1z which are wound around the first branches 140-1x and 140-1y; and second coils 140-2z which are wound around the second branches 140-2x and 140-2y. Moreover, it is assumed that the first branches 140-1x and 140-1y and the second branches 140-2x and 140-2y have the same shape and characteristics, that the characteristics (e.g. the number of turns) of the coil 140-1z which is wound around the first branch 140-1x are the same as the characteristics (e.g. the number of turns) of the coil 140-1z which is wound around the first branch 140-1y, and that the characteristics (e.g. the number of turns) of the coil 140-2z which is wound around the second branch 140-2x are the same as the characteristics (e.g. the number of turns) of the coil 140-2z which is wound around the second branch 140-2y.

Here, in a case where an electric current is applied to the coils 140-1z and 140-2z which are wound around the first branches 140-1x and 140-1y and the second branches 140-2x and 140-2y, respectively, if a force to be pulled toward the direction of the first branch 140-1y and the second branch 140-2y (i.e. a force acting toward a negative direction of the Y-axis, i.e., a downward side in FIG. 6) is generated for the first branch 140-1x and the second branch 140-2x due to the electromagnetic interaction, a force to be pulled toward the direction of the first branch 140-1x and the second branch 140-2x (i.e. a force acting toward a positive direction of the Y-axis, a upward side in FIG. 6) is also generated for the first branch 140-1y and the second branch 140-2y. The forces are opposed to each other and have the same magnitude. The forces thus do not cause acceleration in the exterior and thereon, and only the microvibration is transmitted to a point P1 of the junction of the first branch 140-1x and the first branch 140-1y (in other words, a point P1 on the transmission branch 140b) and a point P2 of the junction of the second branch 140-2x and the second branch 140-2y (in other words, a point P2 on the transmission branch 140b). As a result, forces at the points P1 and P2 are not directional. In the same manner, if a force to be separated from the first branch 140-1y and the second branch 140-2y (i.e. a force acting toward the positive direction of the Y-axis, i.e., the upward side in FIG. 6) is generated for the first branch 140-1x and the second branch 140-2x due to the electromagnetic interaction, a force to be separated from the first branch 140-1x and the second branch 140-2x (i.e. a force acting toward the negative direction of the Y-axis, i.e., the downward side in FIG. 6) is also generated for the first branch 140-1y and the second branch 140-2y. The forces are opposed to each other and have the same magnitude. The forces thus do not cause acceleration in the exterior and thereon, and only the microvibration is transmitted to the point P1 of the junction of the first branch 140-1x and the first branch 140-1y and the point P2 of the junction of the second branch 140-2x and the second branch 140-2y. As a result, forces at the points P1 and P2 are not directional.

However, according to the experiments of the present inventors, it has been found that the microvibration (i.e. the pulsed energy and the non-directional force) is propagated in the inside of the first base 110a due to the aforementioned configuration, resulting in the displacement of the second base 110b along the Y-axis direction and the displacement of the stage 130 along the X-axis direction. In other words, it has been found that the microvibration applied by the driving source part 140 is propagated in the inside of the first base 110a as the non-directional force (in other words, pulsed energy) described above, by which the second base 110b is displaced along the Y-axis direction and the stage 130 is displaced along the X-axis direction.

As described above, in the second example, the second base 110b can be displaced such that the second base 110b resonates along the Y-axis direction at the resonance frequency determined in accordance with the second base 110b and the first suspensions 120a, and the stage 130 can be displaced such that the stage 130 resonates along the X-axis direction at the resonance frequency determined in accordance with the stage 130 and the second suspensions 120b. Here, considering that the stage 130 is connected to the second base 110b via the second suspensions 120b, with the displacement of the second base 110b along the Y-axis direction, the stage 130 is also displaced along the Y-axis direction. As a result, the stage 130 can be displaced such that the stage 130 resonates along each direction of the X-axis and the Y-axis. In other words, in the second example, the stage 130 self-resonates along each direction of the X-axis and the Y-axis.

Here, the “resonance” is a phenomenon in which the repetition of an infinitesimal force causes infinite displacement. Thus, even in the case of a small force to be applied to displace the stage 130, a displacement range of the stage 130 (in other words, an amplitude along the displacement direction) can be set large. In other words, it is possible to set a force required to displace the stage 130 relatively small. It is thus possible to reduce the amount of electric power necessary to apply the force required to displace the stage 130. Therefore, it is possible to displace the stage 130 more efficiently, resulting in lower power consumption of the MEMS actuator 101.

In addition, in the second example, the non-directional force is applied.

Here, as a comparative example, a configuration in which the stage 130 is biaxially driven by applying a so-called directional force (e.g. a configuration in which the first base 110a is greatly vibrated along the displacement direction of the stage 130 and the vibration is directly applied to the first suspensions 120a, the second suspensions 120b, and the stage 130 to drive the stage 130) will be explained. In this case, it is necessary to apply a directional force for displacing the stage 130 along the X-axis direction (i.e. a directional force for greatly vibrating the first base 110a along the X-axis direction) from a particular driving source part 140. It is also necessary to apply a directional force for displacing the stage 130 along the Y-axis direction (i.e. a directional force for greatly vibrating the first base 110a along the Y-axis direction) from another driving source part 140. That is, in the case where the biaxial drive of the stage 130 is performed by applying the directional force, the MEMS actuator needs to be provided with two or more driving source parts 140. In other words, in the case where the biaxial drive of the stage 130 is performed by applying the directional force, because only a force that acts along one direction can be applied from one driving source part 140, and thus, the MEMS actuator needs to be provided with two or more driving source parts 140.

In the second example, however, the stage 130 can be biaxially driven by applying the non-directional force caused by the microvibration. Here, since the non-directional force caused by the microvibration is applied, the microvibration (i.e. the non-directional force) applied from one driving source part 140 allows the stage 130 to be displaced along the X-axis direction and the Y-axis direction using the elasticity of the first suspensions 120a (i.e. the elasticity for displacing the stage 130 along the Y-axis direction) and the elasticity of the second suspensions 120b (i.e. the elasticity for displacing the stage 130 along the X-axis direction). In other words, in the second example, even in the case of the biaxial drive of the stage 130, it is not always necessary to provide two driving source parts 140. Thus, by using a single driving source part 140, the non-directional force caused by the microvibration for biaxially driving the stage 130 can be applied to the first base 110a.

In addition, even if a force acting in two directions can be applied from one driving source part, in the case where the biaxial drive of the stage 130 is performed by applying the directional force, it is eventually necessary to apply a force having components acting along the two directions (i.e. a directional component force for displacing the stage 130 along the X-axis direction and a directional component force for displacing the stage 130 along the Y-axis direction). In the second example, however, since the non-directional force caused by the microvibration is applied as the pulsed energy, there is no need to apply the force in view of a direction of acting the force, which is also advantageous.

In addition, since the non-directional force caused by the microvibration is applied, the placement position of the driving source part 140 is no longer limited. In other words, the application of the non-directional force caused by the microvibration does not cause such a situation that the placement position of the driving source part 140 is limited depending on the displacement direction of the stage 130. That is, regardless of the placement position of the driving source part 140, the non-directional force caused by the microvibration applied from the driving source part 140 allows the stage 130 to be displaced along the X-axis direction and the Y-axis direction using the elasticity of the first suspensions 120a and the elasticity of the second suspensions 120b. This makes it possible to relatively increase the degree of freedom in the design of the MEMS actuator 101. This is extremely useful in practice for the MEMS actuator which is significantly limited in size or design of each constituent.

In addition, in the second example, since the non-directional force caused by the microvibration (i.e. the non-directional microvibration) is applied, it is not necessary to apply the microvibration in view of directions of the actual vibration of the second base 110b and the stage 130. In other words, it is not necessary to apply forces directly acting along directions matching the directions of the actual vibration of the second base 110b and the stage 130. More specifically, as shown in FIG. 6, although a force generated by the first piezoelectric element 140-1a and the second piezoelectric element 140-2a provided for the driving source part 140 acts along the Y-axis direction in FIG. 6, the stage 130 can be displaced along both the X-axis direction and the Y-axis direction. In other words, it is not necessary to generate both the force acting along the X-axis direction in FIG. 6 and the force acting along the Y-axis direction in FIG. 6 using the first piezoelectric element 140-1a and the second piezoelectric element 140-2a provided for the driving source part 140 in order to displace the stage 130 along both the X-axis direction and the Y-axis direction. Thus, regardless of where the driving source part 140 is disposed, the stage 130 can be preferably displaced in a desired direction.

### (3) Third Example

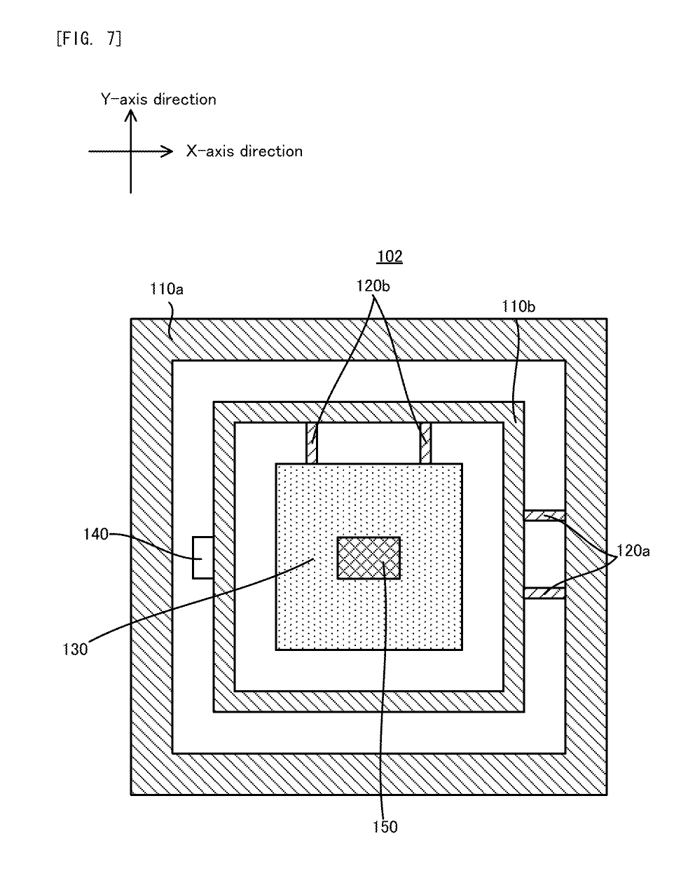

Next, with reference to FIG. 7, a third example of the MEMS actuator will be explained. FIG. 7 is a plan view conceptually showing a basic configuration of a MEMS actuator 102 in the third example. Incidentally, the same constituents as those of the MEMS actuator 100 in the first example and the MEMS actuator 101 in the second example described above will carry the same reference numerals, and the detailed explanation thereof will be omitted.

As shown in FIG. 7, the MEMS actuator 102 in the third example is provided with: a first base 110a; first suspensions 120a; a second base 110b; second suspensions 120b; a stage 130; and a driving source part 140, as in the MEMS actuator 101 in the second example. Incidentally, since the configuration of the driving source part 140 is the same as that of the driving source part 140 in the first example, the driving source part 140 is expressed in a simplified manner.

The MEMS actuator 102 in the third example is different from the MEMS actuator 101 in the second example particularly in the placement position of the driving source part 140. Specifically, in the MEMS actuator 102 in the third example, the driving source part 140 is disposed so as to be connected to the second base 110b. The driving source part 140 in the third example applies, to the second base 110b, a force required to displace the stage 130 along the X-axis direction. This force corresponds to the non-directional force described above. At the same time, the driving source part 140 in the third example applies, to the second base 110b, a force required to displace the second stage 110b along the Y-axis direction. In particular, the driving source part 140 applies, to the second base 110b, a force for relatively greatly vibrating the second base 110b, in order to displace the second base 110b. In other words, the driving source part 140 directly applies to the second base 110b the force for vibrating the second base 110b along the Y-axis direction (i.e. a directional force), thereby displacing the second base 110b in the Y-axis direction.

In order to realize the operation as described above, to the driving source part 140, a signal obtained by superimposing a signal (i.e. a voltage signal for generating microvibration) synchronized with a resonance frequency when the stage 130 is displaced along the X-axis direction on a signal (i.e. a voltage signal) for generating a force for displacing the second base 110b along the Y-axis direction is applied as an input signal.

Thus, according to the MEMS actuator 102 in the third example, the directional force is used to displace the stage 130 (in other words, the second base 110b for supporting the stage 130) along the Y-axis while the non-directional force is used to displace the stage 130 along the X-axis. Even in such a configuration, the biaxial drive of the stage 130 can be preferably performed.

Incidentally, in the third example, the directional force is used to displace the stage 130 along the Y-axis while the non-directional force is used to displace the stage 130 along the X-axis. However, both the directional force and the non-directional force may be used to displace the stage 130 along the X-axis. In other words, in order to displace the stage 130 along a desired axis, only the non-directional force may be used, only the directional force may be used, and a combination of the directional force and the non-directional force may be used.

### (4) Fourth Example

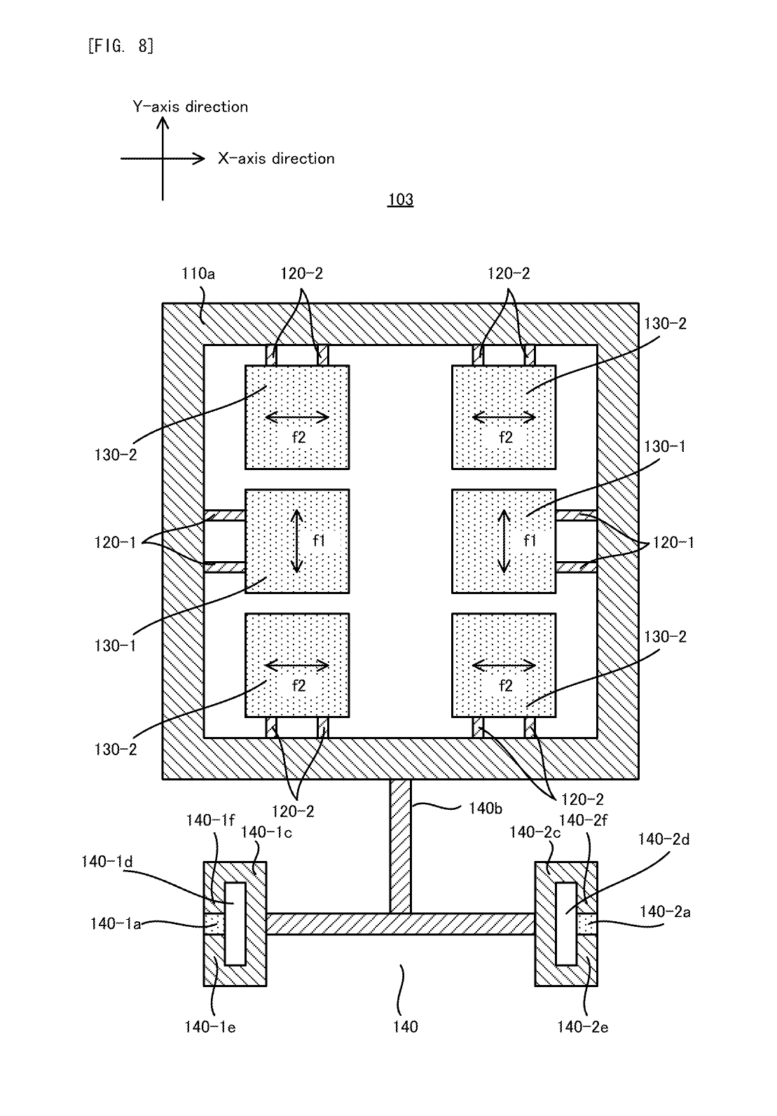

Next, with reference to FIG. 8, a fourth example of the MEMS actuator will be explained. FIG. 8 is a plan view conceptually showing a basic configuration of a MEMS actuator 103 in the fourth example. Incidentally, the same constituents as those of the MEMS actuator 100 in the first example and the MEMS actuator 101 in the second example described above will carry the same reference numerals, and the detailed explanation thereof will be omitted.

As shown in FIG. 8, the MEMS actuator 103 in the fourth example is provided with: a first base 110a; and a driving source part 140, as in the MEMS actuator 101 in the second example.

The MEMS actuator 103 in the fourth example is particularly provided with: a plurality of stages 130-1 each of which is configured to be displaced along the Y-axis direction; a plurality of stages 130-2 each of which is configured to be displaced along the X-axis direction; a plurality of suspensions 120-1 each of which connects the first base 110a and the corresponding stage 130-1 out of the plurality of stages 130-1; and a plurality of suspensions 120-2 each of which connects the first base 110a and the corresponding stage 130-2 out of the plurality of stages 130-2. The MEMS actuator 103 in the fourth example corresponds to a configuration obtained by dividing the stage 130 provided for the MEMS actuator 101 in the second example.

Each of the plurality of suspensions 120-1 has the same configuration and characteristics as those of the first suspension 120a described above. Each of the plurality of suspensions 120-1 is connected to the first base 110a at one end and connected to the corresponding stage 130-1 at the other end. Moreover, each of the plurality of suspensions 120-1 has elasticity for displacing the corresponding stage 130-1 along the Y-axis direction.

Each of the plurality of suspensions 120-2 has the same configuration and characteristics as those of the second suspension 120b described above. Each of the plurality of suspensions 120-2 is connected to the first base 110a at one end and connected to the corresponding stage 130-2 at the other end. Moreover, each of the plurality of suspensions 120-2 has elasticity for displacing the corresponding stage 130-2 along the X-axis direction.

Each of the plurality of stages 130-1 has substantially the same configuration as that of the stage 130 described above, and it is disposed in a space in the inside of the first base 110a so as to be hung or supported by the corresponding suspensions 120-1. Moreover, each of the plurality of stages 130-1 is set to have a resonance frequency of “f1”. In other words, the mass of each of the plurality of stages 130-1 and the spring constant of each of the plurality of suspensions 120-1 are set such that each of the plurality of stages 130-1 has a resonance frequency of “f1”. Moreover, each of the plurality of stages 130-1 is configured to be displaced (in other words, vibrated) along the Y-axis direction by the elasticity of the suspensions 120-1.

Each of the plurality of stages 130-2 has substantially the same configuration as that of the stage 130 described above, and it is disposed in the space in the inside of the first base 110a so as to be hung or supported by the corresponding suspensions 120-2. Moreover, each of the plurality of stages 130-2 is set to have a resonance frequency of “f2”. In other words, the mass of each of the plurality of stages 130-2 and the spring constant of each of the plurality of suspensions 120-2 are set such that each of the plurality of stages 130-2 has a resonance frequency of “f2”. Moreover, each of the plurality of stages 130-2 is configured to be displaced (in other words, vibrated) along the X-axis direction by the elasticity of the suspensions 120-2.

According to the MEMS actuator 103 in the fourth example having such a configuration, since microvibration (i.e. non-directional force) is applied from the driving source part 140 to the first base 110a, a non-directional force caused by the microvibration allows each of the plurality of stages 130-1 to be displaced along the Y-axis direction while resonating at one resonance frequency f1 using the elasticity of each of the plurality of suspensions 120-1 and allows each of the plurality of stages 130-2 to be displaced along the X-axis direction while resonating at another resonance frequency f2 using the elasticity of each of the plurality of suspensions 120-2. More specifically, by supplying the driving source part 140 with a signal obtained by superimposing a signal synchronized with the one resonance frequency f1 and a signal synchronized with the another resonance frequency f2, it is possible to displace the plurality of stages 130-1 while resonating at the one resonance frequency f1 and it is possible to displace the plurality of stages 130-2 while resonating at the another resonance frequency f2. In other words, the supply of only the signal synchronized with the one resonance frequency f1 to the driving source part 140 allows the plurality of stages 130-1 to be displaced while resonating at the one resonance frequency f1 but does not allow the plurality of stages 130-2 to be displaced. In the same manner, the supply of only the signal synchronized with the another resonance frequency f2 to the driving source part 140 allows the plurality of stages 130-2 to be displaced while resonating at the another resonance frequency f2 but does not allow the plurality of stages 130-1 to be displaced. Thus, even if the MEMS actuator 102 is provided with the plurality of stages 130-1 and 130-2 having different resonance frequencies, each of the plurality of stages 130-1 and 130-2 can be preferably displaced by using a single driving source part 140.

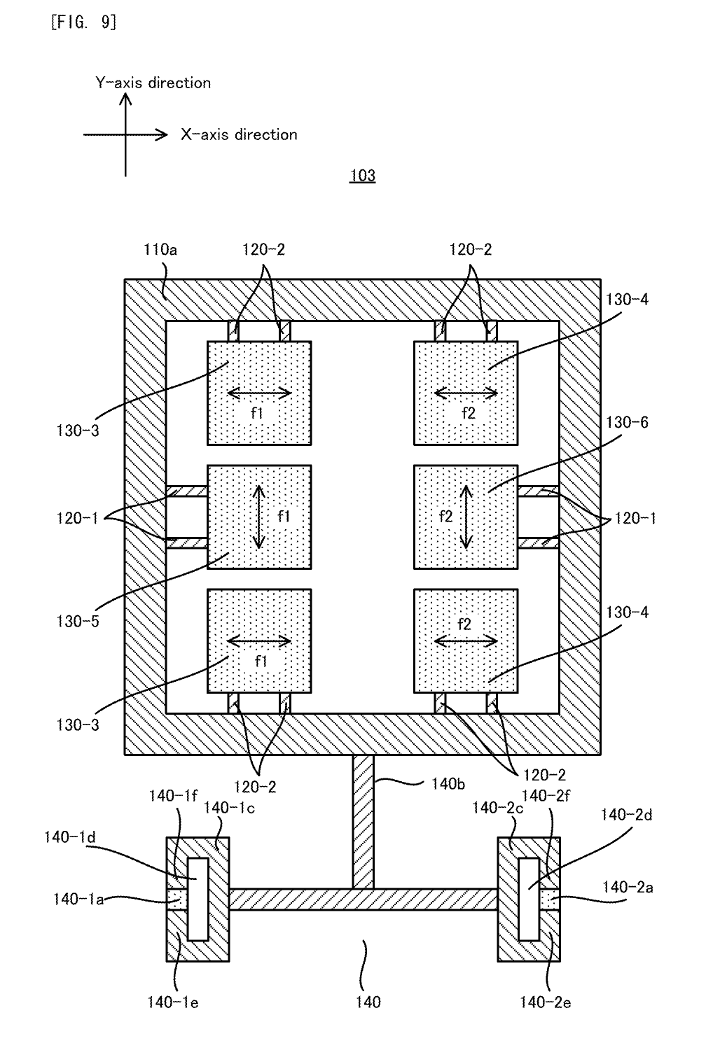

Incidentally, in the aforementioned example, it is explained that each of the plurality of stages 130-1 having a resonance frequency of f1 is displaced along the Y-axis direction and each of the plurality of stages 130-2 having a resonance frequency of f2 is displaced along the X-axis direction. However, it may be configured such that each of the plurality of stages 130 having a resonance frequency of f1 is displaced along the X-axis direction, that each of the plurality of stages 130 having a resonance frequency of f1 is displaced along the Y-axis direction, that each of the plurality of stages 130 having a resonance frequency of f2 is displaced along the X-axis direction, and that each of the plurality of stages 130 having a resonance frequency of f2 is displaced along the Y-axis direction. For example, as shown in FIG. 9, there may be provided: a plurality of first stages 130-3 which are displaced along the X-axis direction while resonating at the one resonance frequency f1; a plurality of second stages 130-4 which are displaced along the X-axis direction while resonating at the another resonance frequency f2; a plurality of third stages 130-5 which are displaced along the Y-axis direction while resonating at the one resonance frequency f1; and a plurality of fourth stages 130-6 which are displaced along the Y-axis direction while resonating at the another resonance frequency f2. In this case, by supplying the driving source part 140 with the signal obtained by superimposing the signal synchronized with the one resonance frequency f1 and the signal synchronized with the another resonance frequency f2, it is possible to displace the plurality of first stages 130-3 along the X-axis direction while resonating at the one resonance frequency f1 and to displace the plurality of third stages 130-5 along the Y-axis direction while resonating at the one resonance frequency f1, and it is possible to displace the plurality of second stages 130-4 along the X-axis direction while resonating them at the another resonance frequency f2 and to displace the plurality of fourth stages 130-6 along the Y-axis while resonating them at the another resonance frequency f2. In other words, the supply of only the signal synchronized with the one resonance frequency f1 to the driving source part 140 allows the plurality of first stages 130-3 to be displaced along the X-axis direction while resonating at the one resonance frequency f1 and allows the plurality of third stages 130-5 to be displaced along the Y-axis direction while resonating at the one resonance frequency f1 but neither allow the plurality of second stages 130-4 to be displaced along the X-axis direction while resonating at the another resonance frequency f2 nor allow the plurality of fourth stages 130-6 to be displaced along the Y-axis direction while resonating at the another resonance frequency f2. In the same manner, the supply of only the signal synchronized with the another resonance frequency f2 to the driving source part 140 allows the plurality of second stages 130-4 to be displaced along the X-axis direction while resonating at the another resonance frequency f2 and allows the plurality of fourth stages 130-6 to be displaced along the Y-axis direction while resonating at the one resonance frequency f2 but neither allow the plurality of first stages 130-3 to be displaced along the X-axis direction while resonating at the one resonance frequency f1 nor allow the plurality of third stages 130-5 to be displaced along the Y-axis direction while resonating at the one resonance frequency f1.

Even if the MEMS actuator 103 is provided with the plurality of stages 130-3 to 130-6 having different resonance frequencies and displacement directions as in this configuration, a desired stage out of the plurality of stages 130-3 to 130-6 can be preferably displaced by using a single driving source part 140.

Incidentally, it is obvious that the various configurations explained in the first example to the third example described above may be applied to the MEMS actuator 103 in the fourth example described above, as occasion demands.

In the present invention, various changes may be made, if desired, without departing from the essence or spirit of the invention which can be read from the claims and the entire specification. A driving apparatus, which involves such changes, is also intended to be within the technical scope of the present invention.

### DESCRIPTION OF REFERENCE CODES

100 MEMS actuator
110 base
120 suspension
130 stage
140 driving source part

1. A driving apparatus comprising:
a base part;
a stage part on which a driven object is mounted and which can be displaced;
an elastic part which connects the base part and the stage part and which has elasticity for displacing the stage part along one direction; and
an applying part for applying, to the base part, microvibration for displacing the stage part such that the stage part resonates along the one direction at a resonance frequency determined by the elastic part and the stage part, wherein
the microvibration is non-directional microvibration as non-directional vibrational energy.

2. The driving apparatus according to claim 1, wherein
the elastic part has elasticity for displacing the stage part along another direction which is different from the one direction, and
the applying part applies, to the base part, the microvibration for displacing the stage part such that the stage part resonates along the one direction at a resonance frequency determined by the elastic part and a suspended part including the stage part and for displacing the stage part such that the stage part resonates along the another direction at a resonance frequency determined by the elastic part and the stage part.

3. The driving apparatus according to claim 2, wherein
the base part comprises a first base part and a second base part which is at least partially surrounded by the first base part,
the elastic part comprises (i) a first elastic part which connects the first base part and the second base part and which has elasticity for displacing the second base part along the one direction and (ii) a second elastic part which connects the second base part and the stage part and which has elasticity for displacing the stage part along the another direction, and
the applying part applies the microvibration for displacing the second base part such that the second base part resonates along the one direction at a resonance frequency determined by the first elastic part and a suspended part including the second base part and for displacing the stage part such that the stage part resonates along the another direction at a resonance frequency determined by the second elastic part and the stage part.

4. The driving apparatus according to claim 3, wherein the applying part applies, to the first base part, the microvibration for displacing the second base part such that the second base part resonates along the one direction at a resonance frequency determined by the first elastic part and the second base part and for displacing the stage part such that the stage part resonates along the another direction at a resonance frequency determined by the second elastic part and the stage part.

5. The driving apparatus according to claim 1, wherein
the stage part is divided into a plurality of stage portions,
the elastic part comprises (i) a third elastic part which connects a first group of stage portions out of the plurality of stage portions and the base part and which has elasticity for displacing the first group of stage portions along at least one of the one direction and another direction which is different from the one direction and (ii) a fourth elastic part which connects a second group of stage portions, which is different from the first group of stage portions, out of the plurality of stage portions and the base part and which has elasticity for displacing the second group of stage portions along at least one of the one direction and the another direction, and
the applying part applies the microvibration for displacing the first group of stage portions such that the first group of stage portions resonate along at least one of the one direction and the another direction at a resonance frequency determined by the third elastic part and the first group of stage portions and for displacing the second group of stage portions such that the second group of stage portions resonate along at least one of the one direction and the another direction at a resonance frequency determined by the fourth elastic part and the second group of stage portions.

6. The driving apparatus according to claim 1, wherein the applying part is a single applying part.

7. The driving apparatus according to claim 1, wherein
the elastic part has elasticity for displacing the stage part along another direction which is different from the one direction, and
the applying part applies each of (i) a driving force for displacing the stage part such that the stage part is displaced along the one direction and (ii) the microvibration for displacing the stage part such that the stage part resonates along the another direction at a resonance frequency determined by the elastic part and the stage part, the microvibration being superimposed on the driving force.

8. The driving apparatus according to claim 7, wherein
the base part comprises a first base part and a second base part which is surrounded by the first base part,
the elastic part comprises (i) a first elastic part which connects the first base part and the second base part and which has elasticity for displacing the second base part along the one direction and (ii) a second elastic part which connects the second base part and the stage part and which has elasticity for displacing the stage part along the another direction, and
the applying part applies each of (i) a driving force for displacing the second base part such that the second base part is displaced along the one direction and (ii) the microvibration for displacing the stage part such that the stage part resonates along the another direction at a resonance frequency determined by the second elastic part and the stage part, the microvibration being superimposed on the driving force.

9. The driving apparatus according to claim 8, wherein the applying part applies, to the second base part, each of (i) the driving force for displacing the second base part such that the second base part is displaced along the one direction and (ii) the microvibration for displacing the stage part such that the stage part resonates along the another direction at the resonance frequency determined by the second elastic part and the stage part, the microvibration being superimposed on the driving force.
